(19) United States
(12) Patent Application Publication
(10) Pub. No.: US 2006/0224385 A1
(43) Pub. Date: Oct. 5, 2006

(54) Text-to-speech conversion in electronic device field

(76) Inventor: Esa Seppala, Tampere (FI)

Correspondence Address: Hollingsworth & Funk, LLC, Suite 125, 8009 34th Avenue South, Minneapolis, MN, 55425, US

(21) Appl. No.: 11/099,152

(22) Filed: Apr. 5, 2005

(51) Int. Cl. G10L 13/08

(52) U.S. Cl. 704/260

(57) ABSTRACT

A solution for text-to-speech conversion is provided. According to the solution, it is checked whether or not a character string comprises a character combination which does not represent a word. If the character string comprises a character combination which does not represent a word, the function of the character combination is analyzed. Based on the analysis, a speech synthesizer is configured to produce a desired speech waveform.

### BACKGROUND

The invention relates to converting text-to-speech in an electronic device.

Text-to-speech conversion and speech synthesizers have been used for decades to convert written text in electrical form to speech waveforms. Quite recently, text-to-speech conversion has spread to chat-based conversation environments. Participants in a chat-service send written messages to a chat-service provider by using a computer, a mobile phone or another communication device. The chat-service provider may then provide the sent messages in a forum common to all participants. The sent messages may be provided in a visual form but they may also be converted to speech waveforms such that the sent messages are also audible.

The forum may be accessed by the participants by using a communication device, or the forum may be broadcast over a television/radio broadcasting network, the Internet, a mobile communication network or another communication network. An example of a former type of forum is an Internet site which provides a chat forum. Participants who wish to attend the chat may access the Internet site and send messages which may be viewed or listened to by other participants. An example of the latter type of forum is a chat-service which is broadcast using a television network. Messages of participants are displayed and/or read on a forum of a television channel. Participants may send messages for example by transmitting SMS (short message service) messages to the chat-service provider. Reading of the messages is based on text-to-speech conversion.

Nowadays, text-to-speech conversion units are able to provide good quality speech from a written text which is in an electronic form. Text-to-speech conversion units are also able to convert certain acronyms representing a determined word into the corresponding word. For example, text-to-speech conversion units pronounce the abbreviation Dr. as “doctor” and not as “dr”.

Quite recently character combinations not representing any determined word have become very common in chat-based conversation environments. For example, character combinations representing an emotion related to a sentence they are associated with are used very frequently. Such character combinations comprise smileys, such as :) (representing happiness, a smile or agreement) and acronyms, such as LOL (laughing out loud). Current text-to-speech conversion units are unable to interpret these character combinations, and pronounce :) as “colon, closing bracket” and LOL as “lol”, or do not pronounce anything. Thus, text-to-speech conversion units are unable to relay an emotion related to a sentence associated with a character combination.

Yahoo! Messenger discloses a chat-based messaging solution, in which determined icons may be included in a message to be sent. When such an icon is clicked, a sound or a sentence associated with the icon is played. In this way, emotions related to the sent message may be relayed to some degree. A current Internet-site for the “audibles” of Yahoo! Messenger may be found at URL: http://messenger.yahoo.com/audibleshome.php. In this solution, the number of possible emotions is limited to the number of available icons, and the solution is not implementable in purely text-based messaging environments.

### BRIEF DESCRIPTION OF THE INVENTION

An object of the invention is to provide an improved solution for text-to-speech conversion.

According to an aspect of the invention, there is provided a method of converting text-to-speech in an electronic device. The method comprises reading a character string, checking whether or not the character string comprises a character combination which has a function other than that of representing a word, analyzing, if a character combination which has a function other than that of representing a word was found, the function of the character combination, and configuring a speech synthesizer to produce a speech wave-form based on the analysis.

According to another aspect of the invention, there is provided an electronic device comprising a speech synthesizer for producing a speech waveform according to input signals and a control unit connected to the speech synthesizer. The control unit is configured to read a character string, check, whether or not the character string comprises a character combination which has a function other than that of representing a word, analyze, if a character combination which has a function other than that of representing a word was found, the function of the character combination, and configure the speech synthesizer to produce a speech waveform based on the analysis.

According to an aspect of the invention, there is provided a electronic device comprising speech synthesizing means for producing a speech waveform according to input signals, means for reading a character string, means for checking whether or not the character string comprises a character combination which has a function other than that of representing a word, means for analyzing, if a character combination which has a function other than that of representing a word was found, the function of the character combination, and means for configuring the speech synthesizing means to produce a speech waveform based on the analysis.

According to an aspect of the invention, there is provided a computer program product encoding a computer program of instructions for executing a computer process for converting text-to-speech in an electronic device. The process comprises reading a character string, checking whether or not the character string comprises a character combination which has a function other than that of representing a word, analyzing, if a character combination which has a function other than that of representing a word was found, the function of the character combination, and configuring a speech synthesizer to produce a speech waveform based on the analysis.

According to an aspect of the invention, there is provided a computer program distribution medium readable by a computer and encoding a computer program of instructions for executing a computer process for converting text-to-speech in an electronic device. The process comprises reading a character string, checking whether or not the character string comprises a character combination which has a function other than that of representing a word, analyzing, if a character combination which has a function other than that of representing a word was found, the function of the character combination, and configuring a speech synthesizer to produce a speech waveform based on the analysis.

An advantage the invention provides over the prior art solutions is an improved user experience for applications such as chat forums and other messaging systems employing text-to-speech conversion, since for example emotions related to messages may be expressed in a better way. Additionally, the invention is implementable in purely text-based messaging systems employing text-to-speech conversion.

### LIST OF DRAWINGS

In the following, the invention will be described in greater detail with reference to embodiments and the accompanying drawings, in which

FIG. 1 illustrates an electronic device in which embodiments of the invention may be implemented;

FIG. 2 illustrates a block diagram of a text-to-speech conversion unit of an electronic device according to an embodiment of the invention;

FIG. 3 illustrates a messaging system in which embodiments of the invention may be implemented, and

FIG. 4 is a flow diagram illustrating a process for text-to-speech conversion according to an embodiment of the invention.

### DESCRIPTION OF EMBODIMENTS

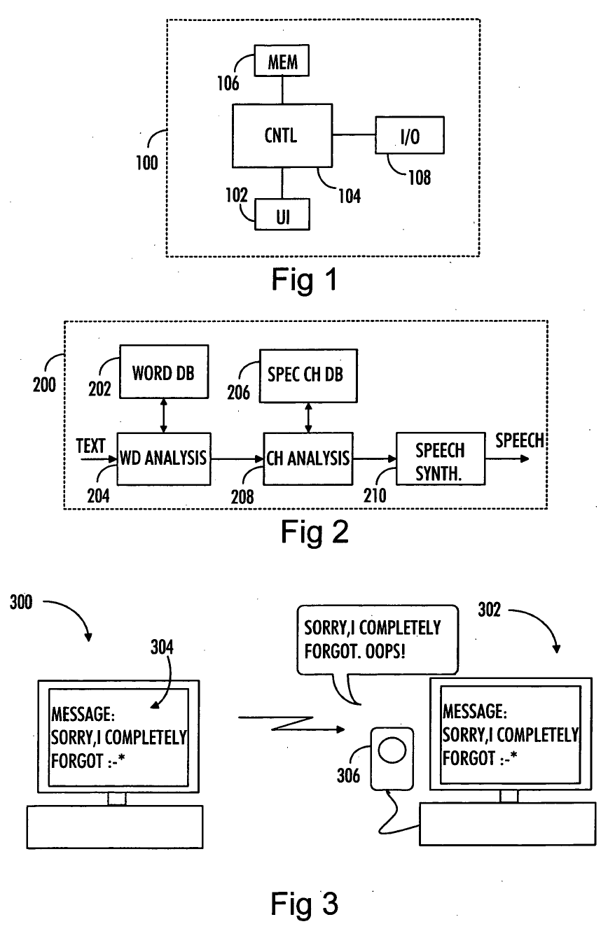

With reference to FIG. 1, examine an example of an electronic device 100 in which embodiments of the invention may be implemented. The electronic device 100 may be for example a computer (such as a personal computer, a laptop or a server computer), a PDA (Personal Digital Assistant.) or a mobile communication device. The electronic device 100 may also be a combination of two electronic devices, such as a computer with a communication device connected to the computer.

The electronic device 100 comprises a control unit 104 for controlling the operation of the electronic device 100. The control unit 104 controls, among other things, text-to-speech conversion in the electronic device 100. The control unit 104 may be implemented by a digital signal processor with suitable software or by employing separate logic circuits, for example ASIC (Application Specific Integrated Circuit). The electronic device may also be a smaller entity, such as a text-to-speech conversion unit.

The electronic device 100 may further comprise a user interface 102 which may comprise at least one display unit for displaying information. The user interface 102 may also comprise a keyboard, a keypad, a mouse and/or another user input device. The user interface may also be implemented with a touch-sensitive display unit. The user interface may further comprise a loudspeaker or a headphone unit for providing a user of the electronic device 100 with audible information.

The electronic device 100 may further comprise an input/output (I/O) interface 108 connected to the control unit 104 for inputting and/or outputting information to/from the electronic device. The I/O interface 108 may also be used for communication with other electronic devices or communication networks. The I/O-interface 108 may utilize either a wired or a wireless communication technology, and the communication technology does not limit the scope of the invention in any way.

The electronic device 100 may further comprise a memory unit 106 for storing and retrieving information. The memory unit 106 may be a hard disc drive, a memory circuit or another non-volatile memory unit.

Next, text-to-speech conversion according to an embodiment of the invention will be described with reference to FIG. 2 which illustrates a block diagram of a text-to-speech conversion unit 200 of the electronic device 100 according to an embodiment of the invention. An input signal inputted into the speech conversion unit comprises text comprising character strings. The character strings comprise words, but the character strings may also comprise other character or character combinations which have a function other than that of representing a word. An example of a character combination which represents a word is ‘Dr’ which represents ‘Doctor’. An example of a character combination which represents a word or words but also has another function, is ‘LOL’ which represents the words ‘laughing out loud’ but also represents an emotion related to the word or words associated with the character combination.

The text-to-speech conversion unit 200 receives a character string. The character string may be in a Unicode format, which is a universal character encoding standard used for representing text for computer processing. The character string may also be in a speech synthesis mark-up language (SSML) format. SSML is a standard mark-up language designed to provide an extensible mark-up language (XML) based mark-up language for assisting generation of synthetic speech in Internet and other applications. The text-to-speech conversion unit 200 comprises a word analysis block 204 which reads the received character string and detects words within the character string. The word analysis block 204 may also expand non-alphabetic words and abbreviations into full-length words. The word analysing block may check a word database 202 for proper full-length words for each non-alphabetic word and abbreviation. For example, when the word analysis block 204 detects the abbreviation ‘Dr’ within a read character string, the word analysis block 204 may check the word database 202 for a proper full-length word for the abbreviation. If an abbreviation has several alternatives for a full-length word (as ‘Dr’ may mean either ‘Doctor’ or ‘Drive’ in an address), the word analysis block 204 may determine the suitable full-length word by examining words preceding and/or following the abbreviation. Numbers may also be expanded into full-length words (as 1 into ‘one’ and 1305 into ‘thirteen oh five’).

The word analysis block 204 may also label the detected words by giving them the correct phonetic sounds. This operation comprises disambiguating the pronunciation of words which are written in the same way but are pronounced differently, such as the word ‘lives’ (has a meaning both as a verb and as a plural noun). Then, the word analysing block 204 predicts sentence phrasing and word accents and, accordingly, generates targets, for example, for fundamental frequency, phoneme duration, and amplitude of each word. These targets are then forwarded to a character analysis block 208, and they are used to configure a speech synthesize block 210 to produce desired speech waveforms.

The character analysis block 208 checks whether or not the character string still comprises character combinations which were not processed by the word analysis block 204. These character combinations may be character combinations describing for example an emotion. When the character analysis block 208 detects a character combination which has not been processed by the word analysis block 204, the character analysis block 208 may check a special character database 206 for the function of the character combination. The special character database may comprise a list of known character combinations and instructions for the character analysis block 208 to perform a determined operation related to each character combination.

When the character analysis block 208 has checked the function of the detected character combination and received instructions related to the character combination, the character analysis block 208 may associate a determined word or words in the character string with the character combination. For example in chat messages, a smiley or an acronym may follow a sentence, the smiley or acronym describing an emotion or a mood associated with the sentence. Thus, the character combination is typically associated with the sentence or words preceding the character combination. Therefore, the character analysis block 208 may associate the character combination for example with the sentence preceding the character combination. This association may be carried out, when the intonation of a word or words of the character string which is associated with the character combination is adjusted based on the function of the character combination. In such a case, it may be necessary to determine which word or words is/are to be adjusted.

Next, the character analysis block 208 configures the speech synthesize block 210 according to the phonetic targets received from the word analysis block and instructions received from the special character database 206. The character analysis block 208 also conveys the configuration information received form the word analysis block 204 to the speech synthesize block 210. The speech synthesize block 210 produces speech waveforms according to the input signals. The speech waveforms produced by the speech synthesize block 210 may still be in an electric form; either analog or digital, whichever is suitable from the implementational point of view.

In the following, examples of operations the character analysis block 208 may carry out based on the instructions in the special character database 206 related to the detected character combination are described. The operations relate to configuring the speech synthesize block 210 to produce desired speech waveforms.

The character analysis block 208 may configure the speech synthesize block 210 to produce a speech waveform describing the emotion related to the character combination. For example, if the character combination is :), the character analysis block 208 may configure the speech synthesize block 210 to produce an artificial, modest laugh. This resembles operations the word analysis block 204 performs. The character analysis block 208 converts the character combination into a “word” and then assigns a phonetic structure to the “word”, i.e. generates targets, for example, for fundamental frequency, phoneme duration, and amplitude of the “word”. Then, based on these targets, the character analysis block 208 configures the speech synthesize block 210 to produce a desired speech waveform.

Alternatively, the character analysis block 208 may configure the speech synthesize block 210 to play a recorded audio sample associated with the character combination. For example, if the character combination is ‘LOL’, the character analysis block 208 may configure the speech synthesize block 210 to play a recorded audio sample describing a person laughing out loud. The recorded audio samples related to every known character combination may be stored in a memory unit of an electronic device employing a text-to-speech conversion unit.

Alternatively, the character analysis block 208 may adjust the pronunciation of words associated with the character combination. The adjustment is naturally based on the function of the character combination. The adjustment may comprise adjusting the targets, for example, for fundamental frequency, phoneme duration, and amplitude of word or words associated with the character combination and received from the word analysis block 204. Thus, the character analysis block 208 may adjust the targets set by the word analysis block 204 to better describe the emotion related to the word or words associated with the character combination. SSML, for example, has a support for defining the pronunciation of sentences. Therefore, if the character analysis block 208 detects, for example, a character combination :—( (sad) associated with a sentence, the character analysis block 208 may configure the speech synthesize block 210 to produce a wave form in which the sentence associated with the character combination :—( is pronounced slowly (rate=x-slow) and with a low pitch (pitch=low). As another example, if the character analysis block 208 detects, for example, a character combination :—} (eager) associated with a sentence, the character analysis block 208 may configure the speech synthesize block 210 to produce a wave form in which the sentence associated with the character combination :—} would correspond to a strongly emphasised (emphasis=strong), a bit high-pitched (pitch=high), and fast (rate=high) speech.

FIG. 3 illustrates a messaging system where embodiments of the invention may be implemented. The messaging system of FIG. 3 is a simple messaging system between a first computer 300 and a second computer 302. It should, however, be appreciated that the scope of the invention is not limited to this kind of messaging system.

A user of the first computer writes a message 304 to a user of the second computer. The message 304 comprises a character combination not describing a word, and the character combination is :—*. Then, the message 304 is transferred to the second computer 302. A text-to-speech conversion unit of the second computer 302 detects the character combination and produces speech waves for the words of the message and for the character combination. In this case, the user of the second computer 302 hears from a loudspeaker 306 connected to the second computer 302 a following acoustic speech signal: “Sorry, I completely forgot! Oops!” Thus, the character combination :—* has been converted to the speech wave ‘Oops’. The speech wave may be produced artificially as other words or it may be a recorded audio sample. Additionally, the intonation of the part ‘Sorry, I completely forgot’ of the sentence may be adjusted to describe the emotion.

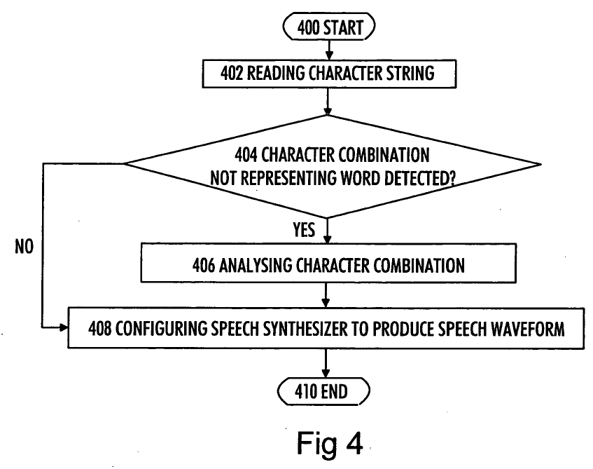

Next, a process for text-to-speech conversion according to an embodiment of the invention will be described with reference to the flow diagram of FIG. 4. The process starts in step 400, and a character string is read in step 402. In step 404, it is checked whether or not the character string comprises a character combination which has a function other than that of representing a word or words. The character combination may be a combination of two or more non-alphabetical characters, a combination of two or more alphabetical characters with the combination not being an abbreviation of a known word, or a combination of both alphabetical and non-alphabetical characters. If a character combination which has a function other than that of representing a word is detected within the character string, the process moves to step 406, and the character combination is analyzed. The analysis comprises analyzing the function of the character combination and determining an operation to be carried out related to the character combination. The analysis may also comprise associating the character combination with a word, words, or a sentence preceding the character combination.

From step 406, the process moves to step 408, where a speech synthesizer is configured to produce a speech waveform. The speech synthesizer may be configured to produce a speech waveform of the character string read in step 402. If a character combination was detected in step 404, the speech synthesizer may be configured to produce a speech waveform according to the analysis carried out in step 406. The speech synthesizer may be configured to play a recorded audio sample related to the character combination, produce a waveform describing the emotion related to the character combination, or to adjust the pronunciation of words associated with the character combination.

If no character combination not describing a word was detected in step 404, the process moves from step 404 to step 408. The process ends in step 410.

The electronic device of the type described above may be used for implementing the method, but also other types of electronic devices may be suitable for the implementation. In an embodiment, a computer program product encodes a computer program of instructions for executing a computer process of the above-described method of text-to-speech conversion. The computer program product may be implemented on a computer program distribution medium. The computer program distribution medium includes all manners known in the art for distributing software, such as a computer readable medium, a program storage medium, a record medium, a computer readable memory, a computer readable software distribution package, a computer readable signal, a computer readable telecommunication signal, and a computer readable compressed software package.

Even though the invention has been described above with reference to an example according to the accompanying drawings, it is clear that the invention is not restricted thereto but it can be modified in several ways within the scope of the appended claims.

1. A method of converting text-to-speech in an electronic device, the method comprising:
reading a character string;
checking whether or not the character string comprises a character combination which has a function other than that of representing a word;
analyzing, if a character combination which has a function other than that of representing a word was found, the function of the character combination, and
configuring a speech synthesizer to produce a speech waveform based on the analysis.

2. The method of claim 1, wherein the character combination describes an emotion.

3. The method of claim 2, further comprising configuring, based on the analysis, the speech synthesizer to produce a speech waveform describing the emotion related to the character combination.

4. The method of claim 1, further comprising checking whether or not the character combination is included in a database comprising known character combinations which have a function other than that of representing a word.

5. The method of claim 1, further comprising:
associating the character combination with a word or words preceding the character combination, and
configuring the speech synthesizer to adjust pronunciation of the word or words associated with the character combination according to the analysis of the character combination.

6. The method of claim 1, further comprising configuring the speech synthesizer to play a recorded audio sample according to the analysis.

7. An electronic device comprising:
a speech synthesizer for producing a speech waveform according to input signals;
a control unit connected to the speech synthesizer, the control unit being configured to:
read a character string;
check, whether or not the character string comprises a character combination which has a function other than that of representing a word;
analyze, if a character combination which has a function other than that of representing a word was found, the function of the character combination, and
configure the speech synthesizer to produce a speech waveform based on the analysis.

8. The electronic device of claim 7, wherein the control unit is further configured to analyze whether or not the character combination describes an emotion related to words associated with the character combination.

9. The electronic device of claim 8, wherein the control unit is further configured to configure, based on the analysis, the speech synthesizer to produce a speech waveform describing the emotion related to the character combination.

10. The electronic device of claim 7, wherein the control unit is further configured to check whether or not the character combination is included in a database comprising known character combinations which have a function other than that of representing a word.

11. The electronic device of claim 7, wherein the control unit is further configured to:
associate the character combination with a word or words preceding the character combination, and
configure the speech synthesizer to adjust pronunciation of the word or words associated with the character combination according to the analysis of the character combination.

12. The electronic device of claim 7, wherein the control unit is further configured to configure the speech synthesizer to play a recorded audio sample according to the analysis.

13. The electronic device of claim 7, the electronic device being a text-to-speech conversion unit.

14. An electronic device comprising:
speech synthesizing means for producing a speech waveform according to input signals;
means for reading a character string;
means for checking whether or not the character string comprises a character combination which has a function other than that of representing a word;
means for analyzing, if a character combination which has a function other than that of representing a word was found, the function of the character combination, and
means for configuring the speech synthesizing means to produce a speech waveform based on the analysis.

15. The electronic device of claim 14, wherein the character combination describes an emotion, the electronic device further comprising means for configuring, based on the analysis, the speech synthesizer to produce a speech waveform describing the emotion related to the character combination.

16. A computer program product encoding a computer program of instructions for executing a computer process for converting text-to-speech in an electronic device, the process comprising:
reading a character string;
checking whether or not the character string comprises a character combination which has a function other than that of representing a word;
analyzing, if a character combination which has a function other than that of representing a word was found, the function of the character combination, and
configuring a speech synthesizer to produce a speech waveform based on the analysis.

17. A computer program product of claim 16, wherein the character combination describes emotion, the process further comprising configuring, based on the analysis, the speech synthesizer to produce a speech waveform describing the emotion related to the character combination.

18. A computer program distribution medium readable by a computer and encoding a computer program of instructions for executing a computer process for converting text-to-speech in an electronic device, the process comprising:
reading a character string;
checking whether or not the character string comprises a character combination which has a function other than that of representing a word;
analyzing, if a character combination which has a function other than that of representing a word was found, the function of the character combination, and
configuring a speech synthesizer to produce a speech waveform based on the analysis.

19. A computer program distribution medium of claim 18, wherein the character combination describes an emotion, the process further comprising configuring, based on the analysis, the speech synthesizer to produce a speech waveform describing the emotion related to the character combination.

20. The computer program distribution medium of claim 18, comprising at least one of the following mediums: a computer readable medium, a program storage medium, a record medium, a computer readable memory, a computer readable software distribution package, a computer readable signal, a computer readable telecommunications signal, a computer readable compressed software package.
